(19) United States
(12) Patent Application Publication
(10) Pub. No.: US 2012/0012610 A1
(43) Pub. Date: Jan. 19, 2012

(54) METHOD FOR DISPENSING CONCENTRATED CLEANING SOLUTION

(75) Inventor: JAMES D. DECKER, LAS VEGAS, NV (US)

(73) Assignee: ECO HOLDINGS LLC, MIAMI, FL (US)

(21) Appl. No.: 12/835,241

(22) Filed: Jul. 13, 2010

(51) Int. Cl. B67D 7/16

(52) U.S. Cl. 222/1

(57) ABSTRACT

A cleaning system has a holder for holding one or more bottles. A precision metered dispenser is selected based on a viscosity of a concentrated cleaning solution to be dispensed and a desired dispensing quantity. Graphical pictorials are provided for illustrating instructions for dispensing and diluting the concentrated cleaning solution.

### BACKGROUND OF THE INVENTION

### Field of the Invention

It has long been desired to make products as concentrated as possible to avoid shipping, packaging and storage costs. Typically, products are concentrated to 10 to 20% with the remainder of the product composed of water and stabilizing agents. Further concentrating has been difficult because there is no effective means of dispensing small quantities without waste. The most successful methods of dispensing more concentrated products has been with portion packaging. Portion packaging is the packaging of very small quantities that are used in their entirety as one detergent portion. These products tend to be expensive to use because the portion packages consume excess packaging materials.

Pumps have been used for decades, but have not been successful because they are not perceived to provide the user any benefit. The smallest pumps used for janitorial detergents are 1 ounce per stroke. The pumps are not linked to any particular product and there is no provision to control the number of pump strokes per container.

The most successful means of dispensing have been with aspirators. Virtually every company in the janitorial industry has a dispensing system built around aspiration. Because of limitations of aspirators ability to dispense at very low concentrations, products used with aspirators are generally not more than 20% active.

A need exists for providing concentrated cleaning solutions in a precision metered dose delivery.

### SUMMARY OF THE INVENTION

It is accordingly an object of the invention to provide a method for dispensing concentrated cleaning solution which overcomes the above-mentioned disadvantages of the heretofore-known methods of this general type.

The present invention utilizes small pumps (⅛, ¼ and 1 ounce per stroke) to dispense very concentrated (up to 100% active) product into spray bottles, buckets and large use solution reservoirs.

The method uses from 2 to 8 unique janitorial/housekeeping products. These products could include all purpose cleaners, neutral cleaners, multi purpose cleaners, heavy duty cleaners, carpet spotters, carpet cleaners, glass cleaners, restroom cleaners, air fresheners, specialty floor products, and other specialty maintenance products.

The product concentrations could be from 10% up to 100%.

For simplicity of use, the products could be packaged in similar packages such as 32 ounce quart bottles. The packaging could be from 12 ounces to 128 ounces.

Each product container is equipped with a pump that is color keyed to the pumps output per stroke. There could be three pumps: yellow for ⅛ ounce, green for ¼ ounce and blue for 1 ounce. Additional pumps might be ½ ounce or 2 ounces. Alternatively, the pumps could be in ml in a range of 4 to 70 ml.

While products typically have use instructions in ounces or ml. per gallon of use solution, these products could have instructions that instruct the user what color pump to use and how many strokes to use for each application. All of these instructions could be in icons eliminating the confusion of different written languages.

Each product formula could be configured for maximum concentration while being able to dispense conveniently using even strokes of ⅛, ¼ or 1 ounce pumps or other similar sized pumps (e.g. metric). As an example, the all purpose cleaner could be used at one ¼ ounce stroke into a spray bottle for typical spray and wipe applications. The same product could be used at one, two or three ¼ ounce strokes into a mop bucket for mopping floors.

For simplicity of training, use and storage, the product containers could fit into a convenient rack, tray or cabinet. This enclosure would be used to organize the containers, keep them secure and to provide simple use instructions. Under each container on the enclosure there could be a single, unambiguous instruction for each application giving the proper color of pump with the proper number of strokes.

Alternative configurations of the trays could include a horizontal or vertical mount. The trays could be mobile with a handle or attached to mobile devices such as mop buckets, housekeeping carts, automatic scrubbers and other mobile devices.

The trays could also have additional features such as a locking cage, hooks or hanger areas for towels or spray bottles, additional cavities for backup concentrate bottles or spray bottles, or a carrying handle.

The dispenser concept utilizes small pumps in a dispenser system. The concept will result in a product line with superior costs to competition resulting in significantly improved margins. The concept is described fully in a Power Point presentation.

The invention contains the characteristics including:

a) Green claims superior to any product on the market;

b) Smaller foot print than current systems;

c) Reduced installation time—installation time is about 5 minutes compared to one or more hours;

d) Number of products to be dispensed to be equal to competitive systems;

e) Pricing to be in line with current systems with gross margins improved by approximately 20%;

f) Easy to train new users;

g) Resolves plumbing cross connection issue;

h) Robust;

i) Easy to repair;

j) Good aesthetics (perception of value);

k) Flexible system (spray bottle, mop buckets, scrubbers);

l) Transportable system is a plus; and

m) Complete starter kits in one box;

n) Compact so that sales person can carry in unit to demonstrate on desk.

Pumps are currently considered low-tech and defeatable by multiple strokes. The invention must address this issue with a high tech perception and cost savings. Housekeepers must accept the new dispensing systems. It has been found through focus groups and field tests that any change of cleaning habits will run into resistance from housekeepers. The new dispensers must be user-friendly; easy to use and reduce the time spent filling the spray bottles. Sales people must also accept the new dispensing systems. The dispenser must be easy to sell and install to overcome sales resistance.

With the foregoing and other objects in view there is provided, in accordance with the invention a method for providing and dispensing concentrated cleaning solutions. The method includes providing a dispensing container with a precision metered dispensing apparatus; providing a holder for the dispensing container, the holder secures the container when the dispensing apparatus dispenses cleaning solution; providing printed indicia instructing an amount of cleaning solution to be dispensed for a particular cleaning application; providing a concentrated cleaning solution in the dispensing container and dispensing the cleaning solution according to the printed indicia; and diluting the dispensed solution.

The concentrated cleaning solution is concentrated in a range from 10-100%. The system metered dispensing apparatus dispenses concentrated cleaning solution in a range of 0.125-2.0 ounces per metered dispensing. With such small amounts, precision of dispensing is important. Many aspirator dispensing systems do not account for accuracy of delivery dependant on viscosity.

The present method addresses this concern and provides precision metered dispensing apparatus that is compatible and accurate for a particular viscosity or viscosity range. A preferred accuracy is delivery of +/−5% of the desired delivery volume, or delivery of 95-105% of the desired delivery volume. The concentrated cleaning solution has a viscosity ranging from 1-2000 cps. Although viscosity range is provided in relation to dynamic viscosity, is known and understood by persons with skill in the art that this range can be analogous to other measurements of viscosity including, but not limited to kinematic, shear, absolute, and other known viscosity measurements.

In one embodiment, the method provides a plurality of containers, each of the containers is color coded to indicate an instruction of number of dispenses of cleaning solution for a particular use.

The dispensing apparatus is constructed and arranged to deliver concentrated cleaning solutions, wherein the solutions are concentrated in a range from 10-100%.

The method includes providing the printed indicia as pictorial instructions or diagrammatic instructions for use of the cleaning solutions.

In the method, the concentrated cleaning solution is diluted with the addition of water between 1-5000 times the volume of dispensed concentrated cleaning solution.

Other features which are considered as characteristic for the invention are set forth in the appended claims.

Although the invention is illustrated and described herein as embodied in a method for dispensing concentrated cleaning solution, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific

### BRIEF DESCRIPTION OF THE DRAWINGS

FIG. 1 is a perspective view of system components according to the invention;

FIG. 2 is a front view of the system components;

FIG. 3 is a side view of the system components;

FIG. 4 is a top view of the system components; and

FIG. 5 is an illustration of an instruction card with written instructions and an instruction card with graphical instructions for using the system.

### DETAILED DESCRIPTION OF THE PREFERRED EMBODIMENT

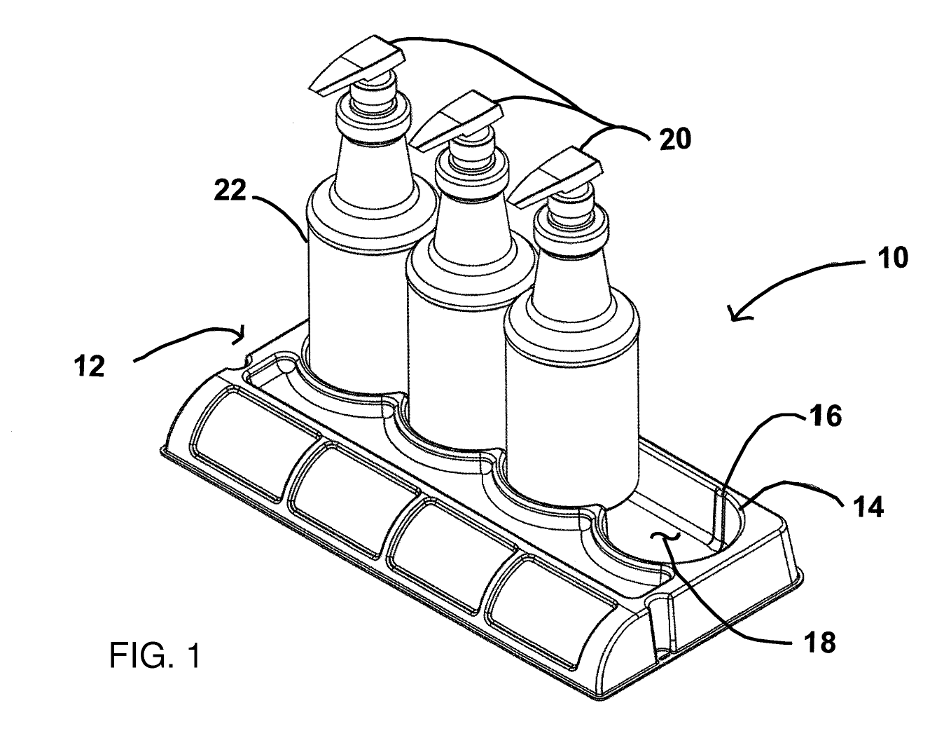

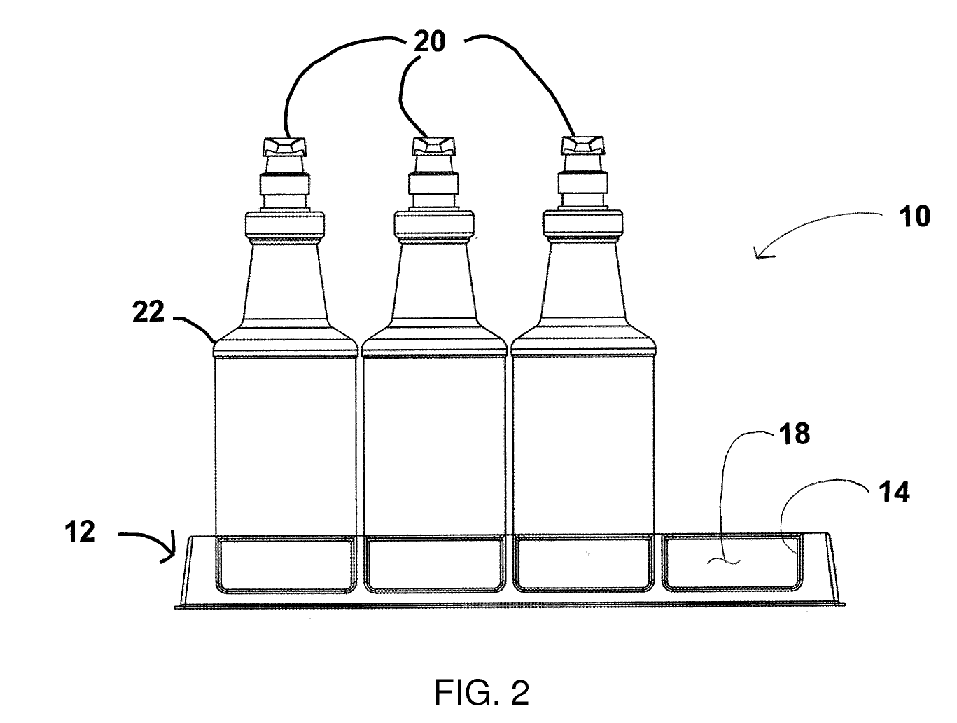

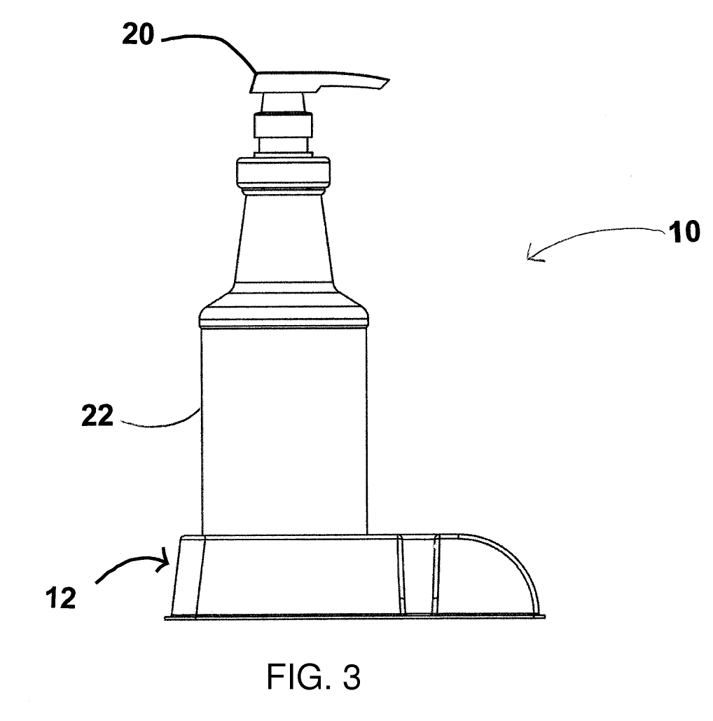

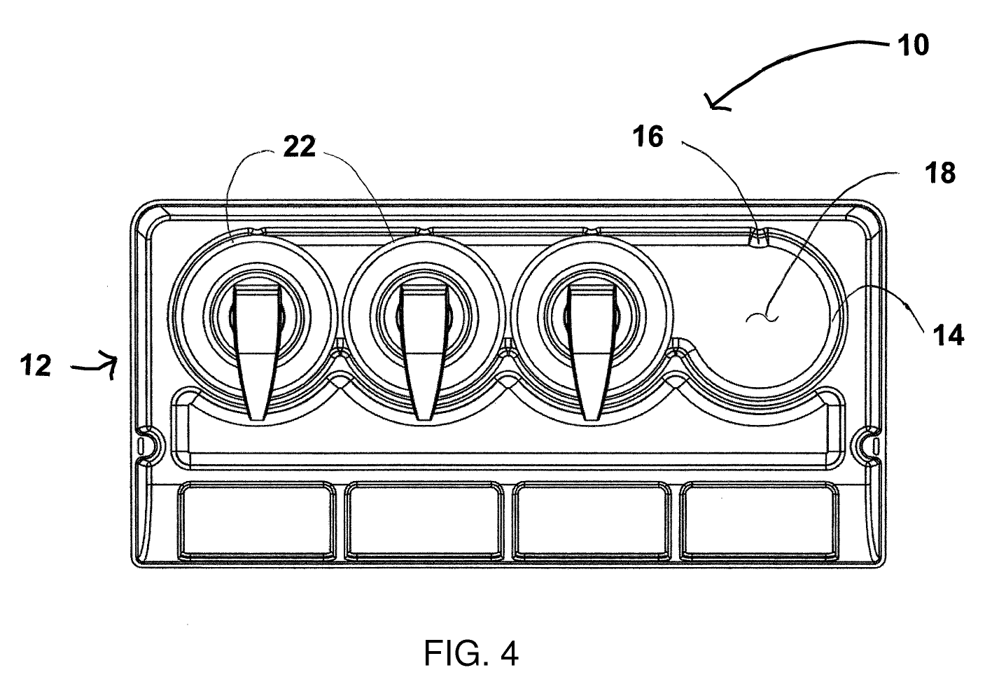

Referring now to the figures of the drawing in detail and first, particularly, to FIGS. 1-4 thereof, there is shown a system 10 which includes a base 12. The base 12 has formed therein one or more receiving holders 14. The receiving holder 14 is constructed and arranged to receive a bottle 22 and secure the bottle 22 in a friction fit arrangement. The receiving holder 14 defines a receiving cavity 18 which is formed with appropriate shape and configuration for receiving the bottle 22. The receiving holder 14 further has incorporated therein a bottle lock 16 that further secures the bottle 22 into the cavity 18 of the receiving holder 14. Each bottle 22 has secured thereto a precision metering dispenser 20.

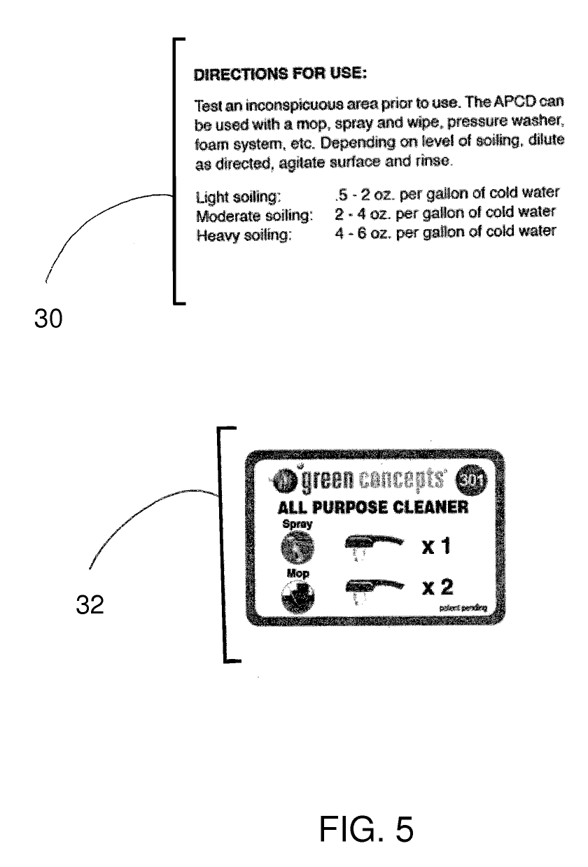

Further contemplated in the invention, as shown in FIG. 5, is replacing written instructions 30 with graphical instructions 32 such that a person utilizing the system of the present invention need not be able to read written instructions 30 in the language presented. Graphical instructions may be affixed directly to the base 12 or near a surface in which the base 12 is secured.

The system 10 is provided with a concentrated cleaning solution in the bottle 22. The concentrated cleaning solution is concentrated in a range from 10-100% and has a viscosity at 25° C. between 1-2000 cps. A user will select a particular bottle 22 and dispense concentrated cleaning solution using the precision metering dispenser 20 in accordance with instructions provided on graphical instructions 32. Dispensing according to graphical instructions 32 can include a single metered dispensing action, or multiple dispensing into a single container which will subsequently be used for diluting said dispensed concentrated solution. The user will subsequently dilute the concentrated cleaning solution according to graphical instructions 32.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

1. A method for providing and dispensing concentrated cleaning solutions, which comprises the steps of:
providing a dispensing container with a precision metered dispensing apparatus;
providing a holder for the dispensing container, the holder secures the dispensing container when the dispensing apparatus dispenses a concentrated cleaning solution;
providing printed indicia instructing an amount of the concentrated cleaning solution to be dispensed for a particular cleaning application;
providing the concentrated cleaning solution in the dispensing container and dispensing the concentrated cleaning solution according to the printed indicia; and
diluting a dispensed solution.

2. The method system of claim 1, which further comprise providing the concentrated cleaning solution in a concentration range from 10-100%.

3. The method of claim 1, which further comprises dispensing the concentrated cleaning solution in a range of 0.125-2.0 ounces per metered dispensing.

4. The method of claim 1, which further comprises providing a plurality of dispensing containers, wherein each of the dispensing containers is color coded to indicate an instruction of number of dispenses of the concentrated cleaning solution for a particular use.

5. The method of claim 1, which further comprises constructing and disposing the dispensing apparatus to deliver the concentrated cleaning solution, wherein the concentrated cleaning solution is concentrated in a range from 10-100%.

6. The method claim 1, which further comprises forming the printed indicia as one of pictorial instructions, diagrammatic instructions, and combinations of the pictorial instructions and the diagrammatic instructions for use of the concentrated cleaning solution.

7. The method of claim 1, which further comprises diluting the concentrated cleaning solution with an addition of water between 1-5000 times a volume of the concentrated cleaning solution dispensed.

8. The method of claim 1, wherein the dispensing apparatus is a precision metered dispensing apparatus which dispenses with an accuracy of 95-105% of desired dispensing volume.

9. The method of claim 1, which further comprises providing the concentrated cleaning solution with a viscosity ranging from 1-2000 cps.
